(19) United States
(12) Patent Application Publication
(10) Pub. No.: US 2016/0334971 A1
(43) Pub. Date: Nov. 17, 2016

(54) Object Manipulation System and Method

(71) Applicant: SIEMENS PRODUCT LIFECYCLE MANAGEMENT SOFTWARE INC., PLANO, TX (US)

(72) Inventors: Thomas James Buchanan, Gernika-Lumo (ES); Kenneth A. Hosch, Redondo Beach, CA (US); Steven Robert Jankovich, Buena Park, CA (US); Daren Rhoades, Laguna Hills, CA (US)

(21) Appl. No.: 14/710,156

(22) Filed: May 12, 2015

(51) Int. Cl. G06F 3/0484; G06F 3/0488

(52) U.S. Cl. CPC G06F 3/04845; G06F 3/04842; G06F 3/04883

(57) ABSTRACT

A system having a processor is provided that visually manipulates objects on a touch screen responsive to inputs through the touch screen. The processor may be responsive to first motion inputs received through an input device to: move a selected first object on a workspace relative to an unselected and unconnected second object on the workspace displayed through a display device while maintaining a size, shape, and orientation of the first object; determine a connection between the selected first object and the unselected second object; and snap the selected first object to a connection position on the workspace such that the first and second objects display a preview of the connection. The processor may form the connection responsive to completion of the first motion inputs. Based on the formed connection, the processor may cause movement of at least a portion of the unselected and connected second object on the workspace responsive to second motions inputs that cause the first object to move on the workspace.

### TECHNICAL FIELD

The present disclosure is directed, in general, to computer-aided design, visualization, and manufacturing systems, product data management (PDM) systems, product lifecycle management (“PLM”) systems, and similar systems, that are used to create and manage data for products and other items (collectively referred to herein as product systems).

### BACKGROUND

Computer-aided design (CAD) systems and other types of drawing systems may include a graphical user interface (GUI) through which drawings of products may be created. Such graphical user interfaces may benefit from improvements.

### SUMMARY

Variously disclosed embodiments include systems and methods that may be used to draw objects in a CAD system or other type of drawing system. In one example, a system may comprise at least one processor configured responsive to first motion inputs received through an input device to: move a selected first object on a workspace relative to an unselected and unconnected second object on the workspace displayed through a display device while maintaining a size, shape, and orientation of the first object; determine a connection between the selected first object and the unselected second object; snap the selected first object to a connection position on the workspace such that the first and second objects display a preview of the connection; and form the connection responsive to completion of the first motion inputs. Based on the formed connection the at least one processor may be configured to cause movement of at least a portion of the unselected and connected second object on the workspace responsive to second motions inputs that cause the first object to move on the workspace.

In another example, a method may include various acts carried out through operation of at least one processor. Such a method may include through operation of at least one processor responsive to first motion inputs received through an input device: moving a selected first object on a workspace relative to an unselected and unconnected second object on the workspace displayed through a display device while maintaining a size, shape, and orientation of the first object; determining a connection between the selected first object and the unselected second object; snapping the selected first object to a connection position on the workspace such that the first and second objects display a preview of the connection; and forming the connection responsive to completion of the first motion inputs. In addition the method may include through operation of the at least one processor responsive to second motions inputs that cause the first object to move on the workspace, based on the formed connection causing movement of at least a portion of the unselected and connected second object on the workspace.

A further example may include non-transitory computer readable medium encoded with executable instructions (such as a software component on a storage device) that when executed, causes at least one processor to carry out this describe method.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the Detailed Description below, it may be advantageous to set forth definitions of certain words or phrases that may be used throughout this patent document. For example, the terms “include” and “comprise,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to describe various elements, functions, or acts, these elements, functions, or acts should not be limited by these terms. Rather these numeral adjectives are used to distinguish different elements, functions or acts from each other. For example, a first element, function, or act could be termed a second element, function, or act, and, similarly, a second element, function, or act could be termed a first element, function, or act, without departing from the scope of the present disclosure.

In addition, phrases such as “processor is configured to” carry out one or more functions or processes, may mean the processor is operatively configured to or operably configured to carry out the functions or processes via software, firmware, and/or wired circuits. For example a processor that is configured to carry out a function/process may correspond to a processor that is actively executing the software/firmware which is programmed to cause the processor to carry out the function/process and/or may correspond to a processor that has the software/firmware in a memory or storage device that is available to be executed by the processor to carry out the function/process. It should also be noted that a processor that is “configured to” carry out one or more functions or processes, may correspond to a processor circuit particularly fabricated or “wired” to carry out the functions or processes (e.g., an ASIC or FPGA design).

The term “adjacent to” may mean: that an element is relatively near to but not in contact with a further element; or that the element is in contact with the further portion, unless the context clearly indicates otherwise.

Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 illustrates a functional block diagram of an example system that facilitates manipulation of drawing objects.

FIG. 2 illustrates examples views of a workspace in which objects are manipulated.

FIG. 3 illustrates a flow diagram of an example methodology that facilitates manipulation of drawing objects.

FIG. 4 illustrates a block diagram of a data processing system in which an embodiment can be implemented.

### DETAILED DESCRIPTION

Various technologies that pertain to drawing systems will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system components may be performed by multiple components. Similarly, for instance, a component may be configured to perform functionality that is described as being carried out by multiple components. The numerous innovative teachings of the present application will be described with reference to exemplary non-limiting embodiments.

Many forms of drawing systems (such as CAD systems) are operative to manipulate various types of visual objects. Such visual objects may include geometric primitives such as line/curve segments, arcs, and splines. Such visual objects may also include 2-D and 3-D shapes such as circles, squares, rectangles, spheres, cones, cylinders, cubes, and cuboids. Such visual objects may also include combinations of simpler visual objects to form complex 2-D or 3-D structures. Thus in general, a drawing object may correspond to any type of graphical object that can be displayed through a display device (such as a display screen) that is capable of being visually manipulated via inputs through an input device with respect to shape, size, orientation, and/or position.

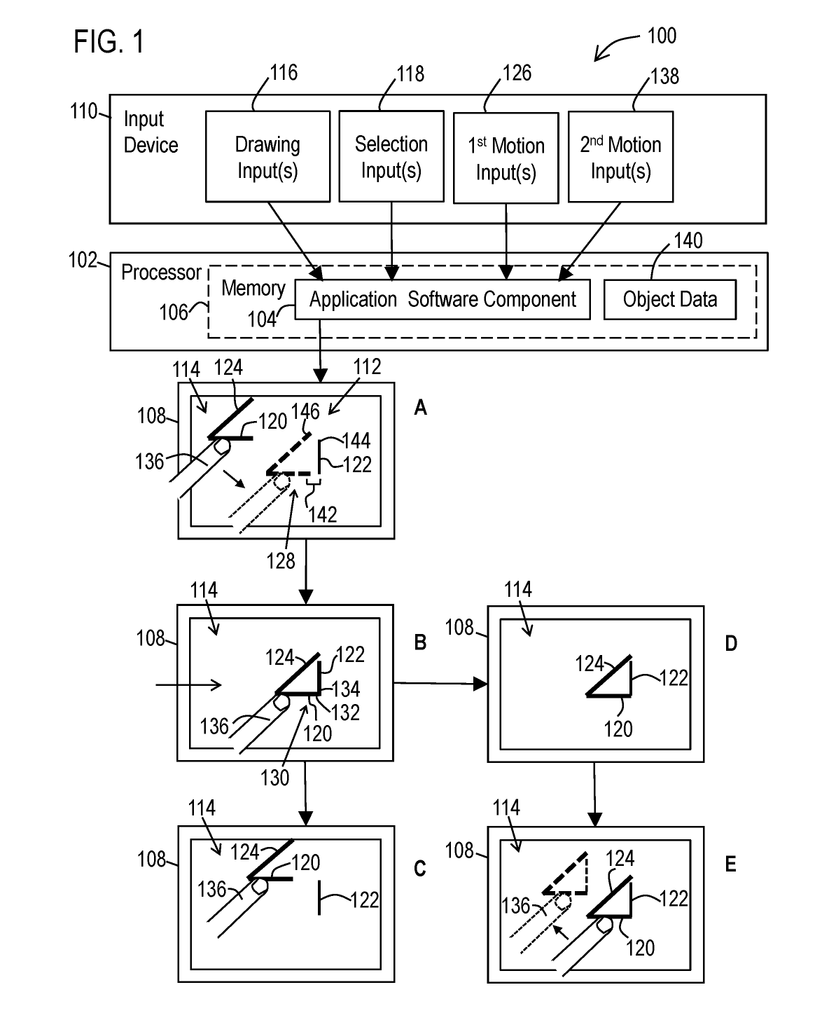

With reference to FIG. 1, an example system 100 that facilitates drawing and manipulating objects is illustrated. The system 100 may include at least one processor 102 that is configured to execute one or more application software components 104 from a memory 106 in order to carry out the various features described herein. The application software component 104 may include a drawing software application or a portion thereof such as a CAD software application. Such a CAD software application may be operative to produce a CAD drawing based at least in part on inputs provided by a user.

An example of CAD/CAM/CAE (Computer-aided design/Computer-aided manufacturing/Computer-aided engineering) software that may be adapted to include at least some of the functionality described herein includes the NX suite of applications that is available from Siemens Product Lifecycle Management Software Inc. (Plano, Tex.). However, it should also be understood that such a drawing software application may correspond to other types of drawing software, including vector based illustration software, presentation software, diagramming software, word processing applications, games, visual programming tools, and/or any other type of software that involves drawing and manipulation of objects.

The described system may include at least one display device 108 (such as a display screen) and at least one input device 110. For example, the processor 102 may be integrated into a housing that includes a touch screen that serves as both an input and display device. Examples of such systems may include mobile phones, tablets, and notebook computers. However, it should be appreciated that example embodiments may use other types of input and display devices. For example, systems may include display devices with display screens that do not include touch screens, such as an LCD monitor or a projector. Further, systems may use other types of input devices to provide inputs for manipulating objects such as a mouse, pointer, touch pad, drawing tablet, track ball, joystick, keypad, keyboard, camera, motion sensing device that captures motion gestures, or any other type of input device capable of providing the inputs described herein.

Further it should be noted that the processor described herein may be located in a server that is remote from the display and input devices described herein. In such an example, the described display device and input device may be included in a client device that communicates with the server (and/or a virtual machine executing on the server) through a wired or wireless network (which may include the Internet). In some embodiments, such a client device for example may execute a remote desktop application or may correspond to a portal device that carries out a remote desktop protocol with the server in order to send inputs from an input device to the server and receive visual information from the server to display through a display device. Examples of such remote desktop protocols include Teradici's PCoIP, Microsoft's RDP, and the RFB protocol. In such examples, the processor described herein may correspond to a virtual processor of a virtual machine executing in a processor of the server.

FIG. 1 schematically illustrates a plurality of different views (A-E) of the display device 108 that are caused to be displayed by the processor 102 in response to various inputs received through the input device 110. For example in view A of the display device 108, the processor 102 may be configured to cause the display device 108 to draw a plurality of objects 112 on a workspace 114 responsive to drawing inputs 116 received through the input device 110. Such a workspace 114 may correspond to a two-dimensional background surface on which objects are drawn, displayed, and manipulated in a graphical user interface of the application software component 104. However, it should also be appreciated that for 3-D drawings, the workspace may correspond to a two dimensional view of a three dimensional space in which objects are visually drawn, displayed, and manipulated using the graphical user interface of the application software component 104. Also in other examples, 3-D displays may be used to render 3-D drawings in a 3-D workspace.

With respect to FIG. 1, the depicted objects 112 may include a first object 120 and a second object 122 which are not connected to each other in view A. Each of these objects may correspond to individual primitive type objects such as lines/curve segments, arcs, ellipses, and/or splines that are part of a curve network. It should be understood that such line/curve segments may be straight and/or curved and a connected group of them may be referred to as a curve set.

It should be understood, that the term “connected” as used herein with respect to connected objects, refers to objects that are constrained in some functional manner. Thus two objects that are merely adjacent to each, (absent some functional relationship) are not connected together. For example, a line end placed adjacent another line end on a workspace may visually appear to be connected. However, absent at least one constraint associated with the visually adjacent line ends, such an example does not correspond to a connection between the two line ends. Rather, a connection of the two line ends may correspond to a constraint that manifests itself in the motion of one line affecting the position/shape/orientation of the other line. Also in some example embodiments, the processor may be configured to show additional indicia on the workspace that illustrates or highlights the constraints created by the connections between objects.

Also it should be appreciated that the application software component 104 may store in the memory 106, information about connections between objects. Such object data regarding connections may be used by the application software to determine how to constrain motions of connected objects responsive to further inputs through the input device 110 directed to one or more of such connected objects.

FIG. 1 also depicts a third object 124 on the workspace that is connected to the first object 120. In this example, the processor is configured to enable any of the first, second, and third objects to be selected for manipulation, while others of these objects remain unselected. For example, such a curve network may permit the first object 120 to be selected, moved, rotated, and scaled

To select an object, the processor 102 may be configured to receive one or more selection inputs 118 through the input device 110. As shown in FIG. 1, such selection inputs 118 may be directed to individual selections of the first object 120 and third object 124, while the second object 122 remains unselected. As shown in view A of the display device, in response to such selection inputs, the processor may cause the first object 120 and third object 124 to be highlighted (via a distinctive bold or colored border or other visual cue) relative to other unselected objects on the workspace 114. For example, as shows in view A of FIG. 1, the second object 122 remains unselected and is not visually highlighted (i.e., does not have a thicker/wider line style).

Also, as shown in view A of the display device, the processor may be configured to be responsive to first motion inputs 126 received through the input device 110 representative of the selected first object 120 being moved with a first motion to move the entire first object 120 and the entire third object 124 on the workspace closer to the second object 122. In this example, because the third object is selected, the entire third object also moves with the motion of the first object on the workspace 114.

Also as shown in view A of FIG. 1, because both the first object 120 and the third object 124 are selected, the processor may be configured to move both the first and third objects as a rigid set in which the sizes, shapes, relative positions, and relative orientations between the first and third objects remains the same as the first and third objects are moved responsive to the first motion inputs 126.

However, it should be understood that because both the first and third objects are connected as well, if the third object 124 was not selected, the processor may also be operative to move at least a portion of the third object based on the constraints associated with the connection between these two objects. For example, as will be discussed in more detail below, other types of objects (connected to the first object but not selected) may have portions that remain stationary as the first object moves, while other portions stretch, change size and/or, pivot to maintain the connection with the first object as the first object moves.

In the examples shown in FIG. 1, a finger 136 is depicted as providing the described drawings inputs 116, selection inputs 118, and motion inputs 126, such as via touching, tapping and sliding the finger across a touch screen. In place of a finger, a stylus may be used in some example embodiments. However, it should also be appreciated that such inputs may be achieved with other types of input devices. For example, the application software component may be responsive to mouse inputs clicking and moving a pointer around the workspace to produce such drawing, selection, and motion inputs. Further, in other examples, a touchpad, gamepad, joystick, trackball, camera, motion sensing device, or other type of input device may be used to provide such inputs.

In example embodiments, it may be desirable to connect objects together, (such as the selected first object 120 to the unselected second object 122). To carry this out, an example embodiment of the processor may be configured to determine one or more candidate connections between the selected first object and the unselected second object while the first object moves on the workspace.

When the first object is relatively close to one of the candidate connections, the processor may be configured to snap the selected first object to a connection position 130 on the workspace which visually represents a preview of the candidate connection between the first and second objects. View B of FIG. 1 shows an example of the first object 120 after it has snapped to a connection position 130 from a prior position 128 (shown in view A) in order to show a preview of the connection.

In this example, the connection that is previewed by the snapping action corresponds to a constraint in which an end 132 of the first line is fixed to an end 134 of the second line. Also, it should be understood that the term snap corresponds to an automatic jump of an object from one position to another (e.g., from prior position 128 to connection position 130) on the workspace rather than a motion from the one position to the other position that is caused by the first motion inputs corresponding to movement from the one position to the other position.

For example, such a jump may be visually perceptible, such as shown in views A and B, in which the finger 136 of the user (providing the first motion inputs 126) does not perceptively move during the snap, but the first object 120 is visibly displaced relative to the user's finger 136 when jumping to the connection position 130.

In an example embodiment, after showing a preview of the connection (with the snap of the first object to the connection position 130), the processor may be configured to form the connection responsive to completion of the first motion inputs. Forming the first connection may correspond to making the preview of the connection persistent such that after the first motion is compete, the connection between the first and second objects remains. In an example embodiment, forming the connection may include storing connection association data between the first and second objects in the object data 140 stored in the memory (and/or in a storage device such as in a drawing file). Such connection association data may specify which portion of the first object is connected to which portion of the second object. The application software component may be responsive to such connection association data to provide constraints on the two objects (e.g., such that movement of one of the connected objects causes movement of at least a portion of the other of the connected objects).

In an example embodiment, completion of the first motion inputs (which causes the persistent connection to be formed) may include a detection by the application software component that a finger or stylus providing such first motions inputs on a touch screen have been lifted off of the touch screen. For a mouse type input device, the completion of the first motion inputs may correspond to a detection of a button up event, in which the mouse button is no longer being depressed by the user to drag the first object around the workspace. For other input devices, the completion of the first motion inputs may correspond to some change in the data provided by the input device that reflects that the user has completed movement of the first object.

In FIG. 1, view D illustrates an example in which the persistent connection between the first and second objects have been formed (e.g., via lifting of the finger 136 from the touch screen). As a result of the formed connection, as illustrated in view E, a user is able to provide second motions inputs 138 through the input device 110 in which the selected first object 120 is again moved around the workspace, while the second object remains unselected. However, because of the formation of the persistent connection between the first and second objects, the processor is configured to cause movement of the unselected and connected second object 122 (or at least a portion thereof) on the workspace responsive to the second motions inputs 138 that cause the first object to move on the workspace.

In an example embodiment (as shown in views A and B of FIG. 1), the processor 102 may be configured to snap the first object to the connection position 130 on the workspace responsive to a determination that first object 120 has moved to within a predetermined distance 142 of the connection position 130. It should also be appreciated that sets of objects may include a plurality of different candidate connection positions at which a moved object may form a desirable connection with one or more stationary objects. For example, the described connection position 130 may correspond to a first connection position, while a second connection position includes the end 132 of the first object being connected to the opposite end 144 of the second object.

In example embodiments, candidate connection positions may correspond to a plurality of different constraints between the selected first object and one or more second objects in which connection points (e.g., line end 132) associated with the first object may be constrained to connection points (e.g., line ends 134, 144) associated with the one or more second. Further, it should be appreciated that when the first object is outside the predetermined distance 142 of each of the determined candidate connection positions on the workspace, the first object may be moved around the workspace without the snapping action being carried out.

In addition, it should be appreciated that each of the first and second objects may include more than two connection points from which candidate positions of the selected first object may be determined for forming connections with one or more unselected second objects, such as opposed ends of objects, center portions of objects, or other locations on, in, or adjacent to the first and second objects (e.g., end-to-end snapping, end-to-curve snapping, end-to-midpoint snapping, end-to-center snapping).

Also, it should be understood that a connection between objects may or may not include the objects visually touching each other. For example, connection points for circles may include the centers of circles and a connection between circles with different diameters may include a constraint in which the centers of the circles remain coincident. As a result, the circles may remain concentric with each other when one of the connected circles is selected and moved on the workspace. Further, such a constraint may correspond to the circles being connected together even though the lines that define the circumferences of the circles do not touch. Also for example, spaced apart and/or intersecting objects may be connected together to maintain a parallel orientation, tangent orientation, or any other type of relationship between the connected objects.

In an example embodiment, prior to the persistent connection between the first and second objects being formed, the processor may be configured to enable a user to unsnap the first object to the second object in order to prevent the connection from being formed and/or to select a different connection position to connect the first object to the second object. For example as illustrated in view C of FIG. 1, (prior to forming the persistent connection) the processor may be configured to unsnap the first object from the connection position 130 and to move the first object 120 away from the second object 122 on the workspace responsive to a determination that the first motion inputs 126 after the first object was snapped to the second object correspond to movement of the first object away from the second object. Such a movement that triggers the unsnapping of the first object 120 may include the motion inputs 126 directing the first object to move at least the predetermined distance 142 (or other predetermined distance) away from the connection position 130.

In addition, the processor 102 may be configured to determine a speed associated with the first object on the workspace that is produced from the first motion inputs while the first object is within the predetermined distance 142 of the connection position. In this example, the processor may be configured to forgo causing the first object to snap to the connection position even though when the first object is within the predetermined distance 142 of the candidate connection position 130, responsive to this determined speed being above a predetermined speed threshold. However, when the determined speed is below the predetermined speed threshold while the first object is within the predetermined distance of the candidate connection position, the processor may be configured to cause the first object 120 to snap to the candidate connection position 130 (such as in view B).

It should also be appreciated that the processor may be configured to dynamically change the predetermined distance and/or the predetermined speed threshold within which the first object is snapped to a candidate connection position depending on one or more different factors which may include: a zoom level associated with the workspace; a size of the first object on the workspace; a size of the second object on the workspace, a size of further objects on the workspace, a number of objects on the workspace, a speed of the first object on the workspace, a number of determined candidate connection positions on the workspace; distances between the respective connection positions on the workspace, and/or user configurable parameters.

In addition, it should be appreciated that when a first object is unsnapped from a second object before the connection between the objects is made persistent, the user may continue to move the object with the first motions 126 in order re-snap the first object to the same connection position or snap the first object to another candidate connection position.

Example embodiments may be operative to display additional visual cues that indicate information about the snapped preview of the connection. For example, the processor may be configured to change a color, boldness, line width, or other visual characteristic of the second object displayed through the display device when the first object is snapped to the connection position. Also, in further embodiments, the position of the connection between the ends 132, 134 may be visually highlighted in order to visually represent the preview of the connection.

In an example embodiment, when two or more connected objects are selected (such as first and third objects 120, 124), the processor may be configured to limit the set of candidate connection positions to only one of the selected objects in order to minimize undesired snapping actions from occurring.

In this example, when two connected objects are selected, the processor may choose to search for candidate positions to snap the particularly selected object that is located at the initial position of the first motion inputs 126 that causes the connected objects to begin to move on the workspace. For example, with a touch screen or mouse input device, the initial position at which the motion inputs begins may correspond to the particular selected object on which the user places their finger, stylus, or mouse pointer, when beginning to drag the selected objects around the workspace.

Thus, as shown in view A of FIG. 1, the processor may be configured to not snap the third object 124 to positions which form a preview of a connection between the upper end 146 of the third object and the upper end 144 of the second object, because the third object is not associated with the initial position of the first motion inputs 126. Rather in this example, the processor is configured to search for candidate connection positions to snap the first object 120 because the user's finger 136 (or stylus, mouse pointer, or other pointer input) is positioned over the first object 120.

In addition, it should be noted that the processor may be operative to select first and third objects at the same time that are not connected together. When multiple unconnected objects are selected, all of the selected objects may be moved around the workspace responsive to the first motions inputs 126 as a rigid set. Also, the processor may be operative to limit the determination of candidate connection positions to only one of the selected unconnected objects. Similar to the example above with respect to connected selected objects, the particular selected object that is used to determine candidate connections with respect to unconnected and selected objects on the workspace, may be chosen based on the initial position of the first motion input that causes the selected objects to begin to move on the workspace. The processor may then forego choosing candidate connection positions for the selected objects that are not associated with the initial position at which the motion inputs begin.

In these examples when multiple objects are selected (whether connected or not), the processor may be configured to cause all of the selected objects to be visually highlighted relative to other non-selected objects so that the user is able to perceive which objects are selected. Also, in order to ensure that the user perceives which particular object in the set of selected objects will be snapped to candidate connection positions, the processor may further be configured to change a color, boldness, line width, or other visual characteristic of the particular object associated with the initial position of the first motion input relative to all of the other selected objects on the workspace.

In an example embodiment, when the application software component is in a mode that enable objects to be moved and connected together as described previously, the processor may also enable multiple objects to be selectable (whether they are connected to each other or not) by tapping with a finger or stylus on the position of each object on a touch screen, without needing to change a mode of the application software component to a specific selection or grouping mode. Similar behavior may be carried out with a mouse or other input device that provides inputs representative of a selection of a set of objects by clicking on them individually. Thus, when each further object is selected, any prior selected objects remain selected.

In this example, to unselect an object, a user may provide a tap or click on the selected object with a finger, stylus, mouse input, or other input at the position of the selected object. Further it should appreciated that when multiple objects are selected in this manner, the processor may be configured to enable the set of objects to move as a rigid group, in which each object maintains its original shape and position with respect to other selected objects in the set.

As discussed previously, unselected objects connected to a selected object (that is being moved) may have the capability of changing size and/or orientation in order to enable an end of the unselected and connected object to remain stationary while another end of the unselected and connected object that is connected to the selected object being moved may move with the movement of the selected object. Such a capability may provide such an unselected and connected object with the functional appearance of a rubber band that can stretch, shrink, and/or pivot as the first object is moved.

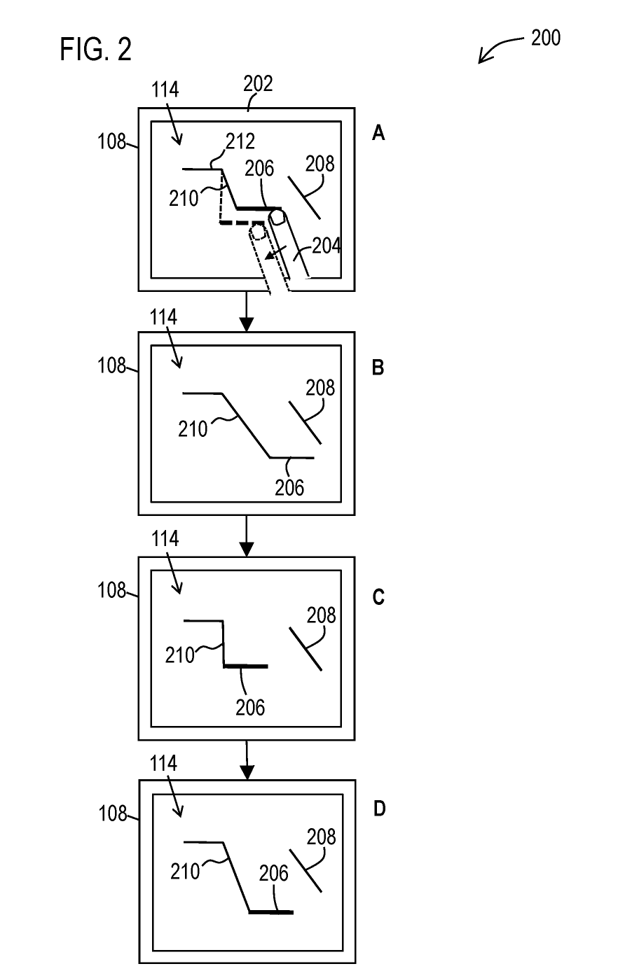

An example of this process is illustrated in FIG. 2, in which a front view 200 of a touch screen 202 is depicted showing a plurality of different views (A-D) of the workspace 114. Such views of the workspace are caused to be displayed on the display device 108 of the touch screen 202 by the processor 102 in a housing associated with the touch screen in response to various inputs received through the input device 110 of the touch screen.

As shown in view A of FIG. 2, a user may take their finger 204 (or a stylus), press down on a displayed first object 206 (e.g., a line segment in this example) and while continuously touching the touch screen 202, move their finger (or stylus) around the workspace, while a unconnected and unselected second object 208 remains stationary on the workspace. It should also be appreciated that this function of dragging the first object may be carried out with mouse inputs or any other type of input device that has the ability provide motion inputs that cause the first object to be moved around the workspace.

In this example, the first object is shown connected to a third object 210, which is connected to a fourth object 212, all of which third and fourth objects are not selected when the user moves the first object 206. Also in this example, the third object 210 has the previously described rubber band characteristic, such that as the user moves the first object 206 around the workspace, the third object 210 stretches, shrinks and/or pivots between the stationary fourth object 212 and the moving first object 206.

As discussed previously, the processor may be configured to determine candidate connection positions at which the selected first object 206 will snap to the second object 208. However, in this described example, the processor may alternatively or additionally be operative to snap the selected first object to further positions in which the third object (with the rubber band characteristic) is in one or more predetermined types of orientation relationships.

Such predetermined types of orientation relationships may include the third object 210 being parallel to at least a portion of the second object 208 (such as in view B of FIG. 2). Such predetermined types of orientation relationships may include the third object 210 being orientated vertically (or horizontally) on the workspace 114, such as in view C of FIG. 2.

In addition, other predetermined types of orientation relationships may include the third object 210: being perpendicular or collinear to the moving first object 206 and/or other connected objects such as the fourth object 212. Further, if the third object is an arc, other predetermined types of orientation relationships may include the third object 210: being tangent to the moving first object 206 and/or other connected objects such as the fourth object 212.

Thus as the first object 206 is being moved around the workspace 114, when the third object 210 is within a predetermined tolerance of having a predetermined type of orientation relationship (e.g., being in an orientation that: is parallel to the second object; is vertically oriented; or is horizontally orientated), the processor may cause the first object 206 to snap to a further position, that places the third object 210 in an orientation that corresponds to the predetermined type of orientation relationship.

Also, as the third object changes orientation as the first object moves, the processor may be configured to store object data in the memory representative of the initial orientation of the third object when the first motion initially began to move the first object. The predetermined types of orientation relationships may include the third object being in an orientation that is aligned with the original path of the third object. Thus as illustrated in view D of FIG. 2, as the first object 206 is being moved around the workspace 114, when the third object 210 is within a predetermined tolerance of being aligned (e.g. coincident and/or axially aligned) with the initial orientation of the third object (as shown in view A), the processor may cause the first object 206 to snap to a further position, that places the third object in an orientation that corresponds to such a predetermined type of orientation relationship.

In FIG. 2 the third object is depicted as a line that changes in size and/or pivots. In addition, it should also be appreciated that an object (such as the third object) which changes in some manner responsive to movement of an object it is connected to, may include other types of objects, such as arcs, circles, ellipses, or other types of geometric primitives or more complex objects. For example, a third object in the form of a circular arc may change in diameter and/or become longer/shorter along the path of the arc about its center point, responsive to movement of the first object that it may be connected to. The predetermined types of orientation relationships may include the third object being in an orientation that is aligned with the original path of the third object (e.g. aligned with the original path of the circular arc with its original radius). Thus as the first object is being moved around the workspace, when the third object (in the form of a circular arc) is within a predetermined tolerance of being aligned with the original path of the circular arc (which may be the same size or shorter or longer than the original arc), the processor may cause the first object to snap to a further position, that places the third object in an orientation that corresponds to such a predetermined type of orientation relationship.

In example embodiments, depending on the type of the third object, such a predetermined tolerance may correspond to a range of orientation angles (such as within 5°) of having an orientation corresponding to a predetermined type of orientation relationship involving being parallel and or aligned) and/or may correspond to a distance threshold of having an orientation corresponding to a predetermined type of orientation relationship involving being aligned with the initial position of the third object or aligned with the original path along which the third object changes in size (e.g., lengthens or shortens).

In an example embodiment, the user interface of the application software component may include (in addition to the workspace) a configuration menu, window or other graphical user interface control that enables a user to set and modify the variously described predetermined tolerances (e.g., thresholds for distance, speeds, angular degrees). Further, as discussed previously such predetermined tolerances may be set dynamically based on characteristics of the workspace, objects, and inputs provided by the user in order to avoid snapping the first object too often in a manner that degrades the ability of the user to smoothly move the first object around the workspace.

In the examples described previously, moving of the selected object(s) responsive to the motion inputs, has been described as a translation of position of the selected object(s) from one location to another location on the workspace. However, it should be appreciated that in example embodiments, motion of the selected objects (e.g., motion of the first object or the first and third objects) on the workspace may be carried out by other operations on the selected object(s) including rotational and scaling motions and/or other more complex operations. For, such operations (involving more than changing the position of the selected objects), the selected object(s) may not move as a rigid set. Rather, one or more of the size(s), shape(s) of the selected object(s) (and/or relative positions/orientations between selected objects) may change as at least portions of the selected object(s) are moved via one of these other types of operations.

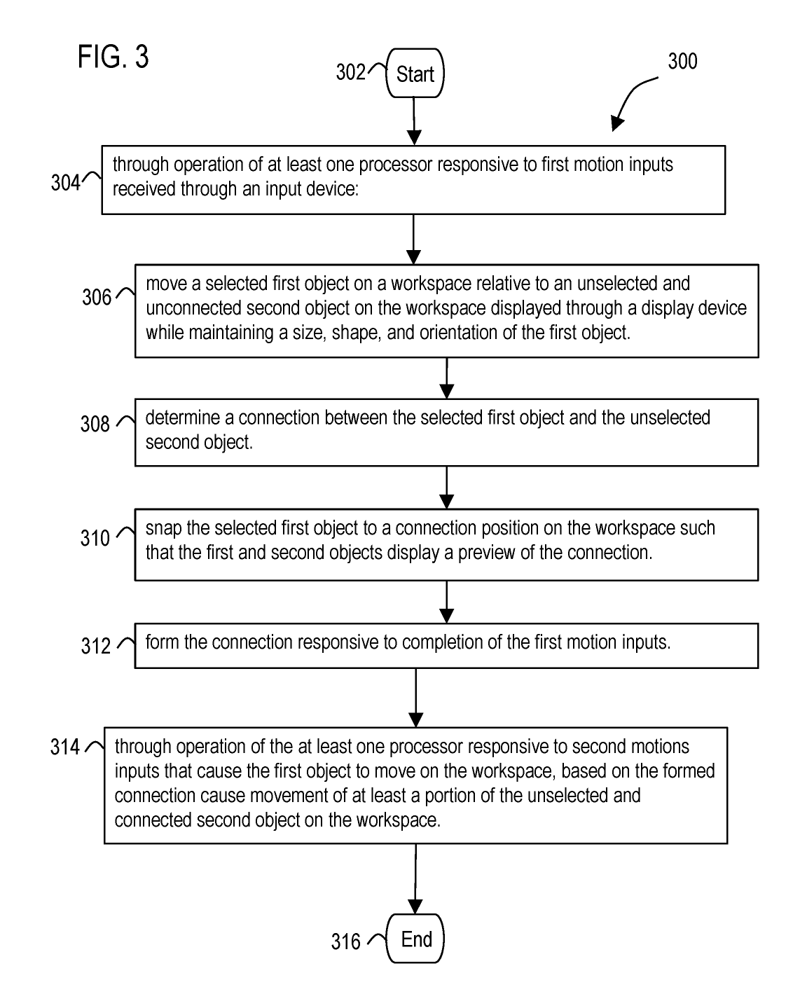

With reference now to FIG. 3, various example methodologies are illustrated and described. While the methodologies are described as being a series of acts that are performed in a sequence, it is to be understood that the methodologies may not be limited by the order of the sequence. For instance, some acts may occur in a different order than what is described herein. In addition, an act may occur concurrently with another act. Furthermore, in some instances, not all acts may be required to implement a methodology described herein.

It is important to note that while the disclosure includes a description in the context of a fully functional system and/or a series of acts, those skilled in the art will appreciate that at least portions of the mechanism of the present disclosure and/or described acts are capable of being distributed in the form of computer-executable instructions contained within non-transitory machine-usable, computer-usable, or computer-readable medium in any of a variety of forms, and that the present disclosure applies equally regardless of the particular type of instruction or signal bearing medium or storage medium utilized to actually carry out the distribution. Examples of non-transitory machine usable/readable or computer usable/readable mediums include: ROMs, EPROMs, magnetic tape, floppy disks, hard disk drives, SSDs, flash memory, CDs, DVDs, and Blu-ray disks. The computer-executable instructions may include a routine, a sub-routine, programs, applications, modules, libraries, a thread of execution, and/or the like. Still further, results of acts of the methodologies may be stored in a computer-readable medium, displayed on a display device, and/or the like.

Referring now to FIG. 3, a methodology 300 that facilitates manipulation of objects is illustrated. The method may start at 302 and at 304 the methodology may include through operation of at least one processor responsive to first motion inputs received through an input device: the act 306 of moving a selected first object on a workspace relative to an unselected and unconnected second object on the workspace displayed through a display device while maintaining a size, shape, and orientation of the first object; the act 308 of determining a connection between the selected first object and the unselected second object; the act 310 of snapping the selected first object to a connection position on the workspace such that the first and second objects display a preview of the connection; and the act 312 of forming the connection responsive to completion of the first motion inputs. In addition the methodology may include that act 314 of through operation of the at least one processor responsive to second motions inputs that cause the first object to move on the workspace, based on the formed connection causing movement of at least a portion of the unselected and connected second object on the workspace. At 316 the methodology may end.

In addition, the methodology 300 may include other acts and features discussed previously with respect to the system 100. For example, the act 310 of snapping the first object to the connection position on the workspace may further be carried out responsive to a determination that the first object has moved to within a predetermined distance of the connection position.

In addition, methodology 300 may further include prior to the act 312 of forming the connection: the act of unsnapping the first object from the connection position and moving the first object away from the second object on the workspace responsive to a determination that the first motion inputs after the first object was snapped to the second object corresponding to movement of the first object away from the second object; and the act of snapping the first object again to the connection position on the workspace responsive to a determination that the first object has moved to within the predetermined distance of the connection position.

Also, the methodology 300 may include; the act of determining a speed associated with the first object on the workspace produced from the first motion inputs; and prior to the act 310 of snapping the first object to the connection position; forgoing causing the first object to snap to the connection position responsive to the first object being within the predetermined distance of the connection position with a determined speed that is above a predetermined speed. In this example, the act 310 of snapping the first object to the connection position may be carried responsive to the first object being within the predetermined distance of the connection position with a determined speed that is under the predetermined speed.

In a further example of the methodology 300, the connection position may be one of a plurality of candidate connection positions in which the first object is connectable to the second object. Also, the methodology 300 may further include: the act of determining the plurality of candidate connection positions; and the act of dynamically changing at least one of the predetermined distance or the predetermined speed used to determine when to snap the first object to the candidate connection positions based at least in part on: a zoom level associated with the workspace; a size of the first object on the workspace; a size of the second object on the workspace, a size of further objects on the workspace, a number of objects on the workspace, a speed of the first object on the workspace, a number of determined candidate connection positions on the workspace; distances between the respective connection positions on the workspace, and/or user configurable parameters.

The example methodology 300 may also include the act of causing the display device to display a third object on the workspace, which third object is unconnected to the second object. In addition, the methodology may include the act of causing the first and third objects to be individually selected in a sequence via respective different selection inputs provided sequentially through the input device, such that an initially selected one of the first and third objects remains selected when a subsequent one of the second and third objects is selected. Further, responsive to selections of both the first and third objects and the first motion inputs, the methodology may include moving the first and third objects as a set in which the sizes, shapes, relative positions, and/or relative orientations between the first and third objects remains the same as the first and third objects are moved on the workspace.

In an example embodiment, the first motion inputs may initially begin at an initial position associated with the first object and not the third object. In such cases, the example methodology may include determining a connection between the first object and the unselected second object and forgoing determining a connection between the third object and the unselected second object responsive to the first object being associated with the initial position of the first motion input.

In addition, the methodology 300 may include: the act of causing the display device to display a third object on the workspace connected to the first object, wherein the third object may be unselected when the first object is selected and is moved with the first motion inputs on the workspace. Also as the first object moves on the workspace, the methodology may include causing the third object to change in size and/or pivot on the workspace to maintain a connection with the first object. Further, as the first object moves on the workspace, the methodology may include determining that the third object is within predetermined tolerances of having a predetermined type of orientation relationship, and responsive hereto, the act of causing the first object to snap to a further position that places the third object in an orientation that corresponds to the predetermined type of orientation relationship.

Also in an example embodiment of the methodology, the predetermined type of orientation relationship may include at least one of: the third object being aligned with an initial path of the third object when the first motion inputs began; the third object being vertically orientated on the workspace; the third object being horizontally aligned on the workspace; the third object being parallel to at least the portion of the second object; the third object being perpendicular to the first object; the third object being collinear to the first object; the third object being tangent to the first object; the third object being perpendicular to a fourth unselected object connected to the third object; the third object being collinear to the fourth object; and/or the third object being tangent to the fourth object.

As discussed previously, such acts associated with these methodologies may be carried out by one or more processors. Such processor(s) may be included in one or more data processing systems for example that execute software components operative to cause these acts to be carried out by the one or more processors. In an example embodiment, such software components may be written in software environments/languages/frameworks such as Java, JavaScript, Python, C, C#, C++ or any other software tool capable of producing components and graphical user interfaces configured to carry out the acts and features described herein.

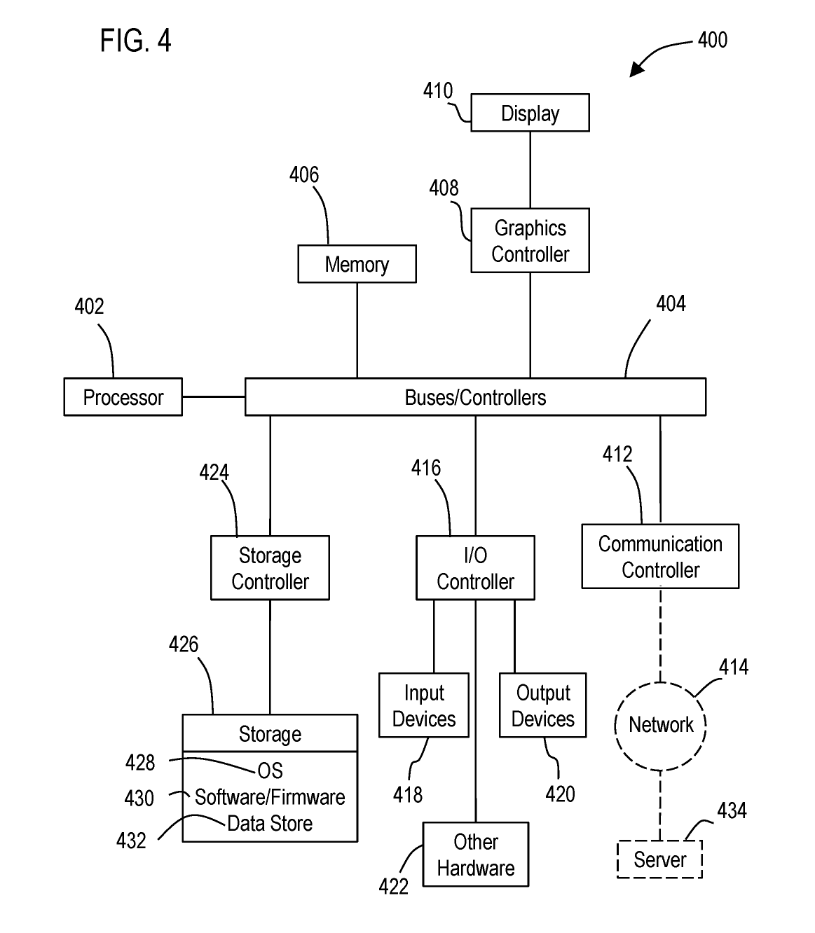

FIG. 4 illustrates a block diagram of a data processing system 400 (also referred to as a computer system) in which an embodiment can be implemented, for example as a portion of a PLM, CAD, and/or drawing system operatively configured by software or otherwise to perform the processes as described herein. The data processing system depicted includes at least one processor 402 (e.g., a CPU) that may be connected to one or more bridges/controllers/buses 404 (e.g., a north bridge, a south bridge). One of the buses 404 for example may include one or more I/O buses such as a PCI Express bus. Also connected to various buses in the depicted example may include a main memory 406 (RAM) and a graphics controller 408. The graphics controller 408 may be connected to one or more display devices 410. It should also be noted that in some embodiments one or more controllers (e.g., graphics, south bridge) may be integrated with the CPU (on the same chip or die). Examples of CPU architectures include IA-32, x86-64, and ARM processor architectures.

Other peripherals connected to one or more buses may include communication controllers 412 (Ethernet controllers, WiFi controllers, cellular controllers) operative to connect to a local area network (LAN), Wide Area Network (WAN), a cellular network, and/or other wired or wireless networks 414 or communication equipment.

Further components connected to various busses may include one or more I/O controllers 416 such as USB controllers, Bluetooth controllers, and/or dedicated audio controllers (connected to speakers and/or microphones). It should also be appreciated that various peripherals may be connected to the USB controller (via various USB ports) including input devices 418 (e.g., keyboard, mouse, touch screen, trackball, gamepad, camera, microphone, scanners, motion sensing devices), output devices 420 (e.g., printers, speakers) or any other type of device that is operative to provide inputs or receive outputs from the data processing system. Further it should be appreciated that many devices referred to as input devices or output devices may both provide inputs and receive outputs of communications with the data processing system. Further it should be appreciated that other peripheral hardware 422 connected to the I/O controllers 416 may include any type of device, machine, or component that is configured to communicate with a data processing system.

Additional components connected to various busses may include one or more storage controllers 424 (e.g., SATA). A storage controller may be connected to a storage device 426 such as one or more storage drives and/or any associated removable media, which can be any suitable non-transitory machine usable or machine readable storage medium. Examples, include nonvolatile devices, volatile devices, read only devices, writable devices, ROMs, EPROMs, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also in some examples, a storage device such as an SSD may be connected directly to an I/O bus 404 such as a PCI Express bus.

A data processing system in accordance with an embodiment of the present disclosure may include an operating system 428, software/firmware 430, and data stores 432 (that may be stored on a storage device 426). Such an operation system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may include Microsoft Windows, Linux, UNIX, iOS, and Android operating systems.

The communication controllers 412 may be connected to the network 414 (not a part of data processing system 400), which can be any public or private data processing system network or combination of networks, as known to those of skill in the art, including the Internet. Data processing system 400 can communicate over the network 414 with one or more other data processing systems such as a server 434 (also not part of the data processing system 400). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

Further, the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely.

In addition, it should be appreciated that data processing systems may be implemented as virtual machines in a virtual machine architecture or cloud environment. For example, the processor 402 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system may vary for particular implementations. For example the data processing system 400 in this example may correspond to a computer, workstation, and/or a server. However, it should be appreciated that alternative embodiments of a data processing system may be configured with corresponding or alternative components such as in the form of a mobile phone, tablet, controller board or any other system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, which may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 400 may conform to any of the various current implementations and practices known in the art.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element which must be included in the claim scope: the scope of patented subject matter is defined only by the allowed claims. Moreover, none of these claims are intended to invoke 35 USC §112(f) unless the exact words “means for” are followed by a participle.

What is claimed is:

1. A system comprising:
at least one processor configured responsive to first motion inputs received through an input device to:
move a selected first object on a workspace relative to an unselected and unconnected second object on the workspace displayed through a display device while maintaining a size, shape, and orientation of the first object,
determine a connection between the selected first object and the unselected second object,
snap the selected first object to a connection position on the workspace such that the first and second objects display a preview of the connection, and
form the connection responsive to completion of the first motion inputs, wherein based on the formed connection the at least one processor is configured to cause movement of at least a portion of the unselected and connected second object on the workspace responsive to second motions inputs that cause the first object to move on the workspace.

2. The system according to claim 1, wherein the at least one processor is configured to snap the first object to the connection position on the workspace responsive to a determination that the first object has moved to within a predetermined distance of the connection position.

3. The system according to claim 2, wherein the at least one processor is configured to unsnap the first object from the connection position and to move the first object away from the second object on the workspace prior to the connection being formed responsive to a determination that the first motion inputs after the first object was snapped to the second object correspond to movement of the first object away from the second object.

4. The system according to claim 2, wherein the at least one processor is configured to determine a speed associated with the first object on the workspace that is produced from the first motion inputs, wherein the at least one processor is configured to forgo causing the first object to snap to the connection position responsive to the first object being within the predetermined distance of the connection position with a determined speed that is above a predetermined speed, wherein the at least one processor is configured to cause the first object to snap to the connection position responsive to the first object being within the predetermined distance of the connection position with a determined speed that is under the predetermined speed.

5. The system according to claim 4, wherein the connection position is one of a plurality of candidate connection positions that the at least one processor is configured to determine in which the first object is connectable to the second object, wherein the at least one processor is configured to dynamically change at least one of the predetermined distance or the predetermined speed used to determine when to snap the first object to the candidate connection positions based at least in part on: a zoom level associated with the workspace; a size of the first object on the workspace; a size of the second object on the workspace, a size of further objects on the workspace, a number of objects on the workspace, a speed of the first object on the workspace, a number of determined candidate connection positions on the workspace; distances between the respective connection positions on the workspace, and/or user configurable parameters.

6. The system according to claim 2, wherein the at least one processor is configured to cause the display device to display a third object on the workspace that is unconnected to the second object, where the processor is configured to enable the first and third objects to be individually selected in a sequence via respective different selection inputs provided sequentially through the input device, such that an initially selected one of the first and third objects remains selected when a subsequent one of the second and third objects is selected, wherein the processor is configured to be responsive to the selection of both the first and third objects to move both the first and third objects as a set in which the sizes, shapes, relative positions, and/or relative orientations between the first and third objects remains the same as the first and third objects are moved responsive to the first motion inputs.

7. The system according to claim 6, wherein the processor is configured to determine that the first motion inputs initially begin at an initial position associated with the first object and not the third object, wherein the first motion inputs cause both the first object and the third object to move, wherein the at least one processor is configured to determine a connection between the first object and the unselected second object and forgo determining a connection between the third object and the unselected second object responsive to the first object being associated with the initial position of the first motion input.

8. The system according to claim 4, wherein the at least one processor is configured to cause the display device to display a third object on the workspace connected to the first object, wherein when the third object is unselected and the first object is selected and is moved with the first motion inputs on the workspace, the third object changes in size and/or pivots on the workspace to maintain a connection with the first object, wherein as the first object moves on the workspace, when the third object is within predetermined tolerances of having a predetermined type of orientation relationship, the processor causes the first object to snap to a further position that places the third object in an orientation that corresponds to the predetermined type of orientation relationship.

9. The system according to claim 8, wherein the a predetermined type of orientation relationship includes at least one of: the third object being aligned with an initial path of the third object when the first motion inputs began; the third object being vertically orientated on the workspace; the third object being horizontally aligned on the workspace; the third object being parallel to at least the portion of the second object; the third object being perpendicular to the first object; the third object being collinear to the first object; the third object being tangent to the first object; the third object being perpendicular to a fourth unselected object connected to the third object; the third object being collinear to the fourth object; and/or the third object being tangent to the fourth object.

10. The system according to claim 1, further comprising a memory, an application software component, and a touch screen comprised of the input device and the display device, wherein the application software component is comprised of instructions that when included in the memory and executed by the at least one processor, cause the at least one processor to manipulate the objects outputted through the touch screen responsive to inputs through the touch screen, wherein the application software component corresponds to a CAD software application that is operative to produce a CAD drawing based at least in part on the inputs through the touch screen.

11. A method comprising:
through operation of at least one processor responsive to first motion inputs received through an input device:
moving a selected first object on a workspace relative to an unselected and unconnected second object on the workspace displayed through a display device while maintaining a size, shape, and orientation of the first object;
determining a connection between the selected first object and the unselected second object;
snapping the selected first object to a connection position on the workspace such that the first and second objects display a preview of the connection; and
forming the connection responsive to completion of the first motion inputs, and
through operation of the at least one processor responsive to second motions inputs that cause the first object to move on the workspace, based on the formed connection causing movement of at least a portion of the unselected and connected second object on the workspace.

12. The method according to claim 11, wherein snapping the first object to the connection position on the workspace is further carried out responsive to a determination that the first object has moved to within a predetermined distance of the connection position.

13. The method according to claim 12, further comprising:
prior to forming the connection, unsnapping the first object from the connection position and moving the first object away from the second object on the workspace responsive to a determination that the first motion inputs after the first object was snapped to the second object corresponding to movement of the first object away from the second object; and
snapping the first object again to the connection position on the workspace responsive to a determination that the first object has moved to within the predetermined distance of the connection position.

14. The method according to claim 12, further comprising:
determining a speed associated with the first object on the workspace produced from the first motion inputs; and
prior to snapping the first object to the connection position, forgoing causing the first object to snap to the connection position responsive to the first object being within the predetermined distance of the connection position with a determined speed that is above a predetermined speed,
wherein snapping the first object to the connection position is carried responsive to the first object being within the predetermined distance of the connection position with a determined speed that is under the predetermined speed.

15. The method according to claim 14, wherein the connection position is one of a plurality of candidate connection positions in which the first object is connectable to the second object, further comprising:
determining the plurality of candidate connection positions; and
dynamically changing at least one of the predetermined distance or the predetermined speed used to determine when to snap the first object to the candidate connection positions based at least in part on: a zoom level associated with the workspace; a size of the first object on the workspace; a size of the second object on the workspace, a size of further objects on the workspace, a number of objects on the workspace, a speed of the first object on the workspace, a number of determined candidate connection positions on the workspace; distances between the respective connection positions on the workspace, and/or user configurable parameters.

16. The method according to claim 12, further comprising:
causing the display device to display a third object on the workspace, which third object is unconnected to the second object;
causing the first and third objects to be individually selected in a sequence via respective different selection inputs provided sequentially through the input device, such that an initially selected one of the first and third objects remains selected when a subsequent one of the second and third objects is selected; and
responsive to selections of both the first and third objects and the first motion inputs, moving the first and third objects as a set in which the sizes, shapes, relative positions, and/or relative orientations between the first and third objects remains the same as the first and third objects are moved on the workspace.

17. The method according to claim 16, wherein the first motion inputs initially begin at an initial position associated with the first object and not the third object, further comprising:
determining a connection between the first object and the unselected second object and forgoing determining a connection between the third object and the unselected second object, responsive to the first object being associated with the initial position of the first motion input.

18. The method according to claim 14, further comprising:
causing the display device to display a third object on the workspace connected to the first object, wherein the third object is unselected when the first object is selected and is moved with the first motion inputs on the workspace;
as the first object moves on the workspace, causing the third object to changes in size and/or pivot on the workspace to maintain a connection with the first object; and
as the first object moves on the workspace, determining that the third object is within predetermined tolerances of having a predetermined type of orientation relationship, and responsive hereto, causing the first object to snap to a further position that places the third object in an orientation that corresponds to the predetermined type of orientation relationship.

19. The method according to claim 18, wherein the a predetermined type of orientation relationship includes at least one of: the third object being aligned with an initial path of the third object when the first motion inputs began; the third object being vertically orientated on the workspace; the third object being horizontally aligned on the workspace; the third object being parallel to at least the portion of the second object; the third object being perpendicular to the first object; the third object being collinear to the first object; the third object being tangent to the first object; the third object being perpendicular to a fourth unselected object connected to the third object; the third object being collinear to the fourth object; and/or the third object being tangent to the fourth object.

20. A non-transitory computer readable medium encoded with executable instructions that when executed, cause at least one processor to carry out a method comprising:
responsive to first motion inputs received through an input device:
moving a selected first object on a workspace relative to an unselected and unconnected second object on the workspace displayed through a display device while maintaining a size, shape, and orientation of the first object;
determining a connection between the selected first object and the unselected second object;
snapping the selected first object to a connection position on the workspace such that the first and second objects display the a preview of the connection; and
forming the connection responsive to completion of the first motion inputs, and
responsive to second motions inputs that cause the first object to move on the workspace, based on the formed connection causing movement of at least a portion of the unselected and connected second object on the workspace.
